(19) United States
(12) Patent Application Publication
(10) Pub. No.: US 2010/0254795 A1
(43) Pub. Date: Oct. 7, 2010

(54) MODULAR CEMENTED PLANAR STRUCTURE

(75) Inventors: Izhar Halahmi, Hod Hasharon (IL); Oded Erez, Tel Aviv (IL); Adi Erez, Tel Aviv (IL)

Correspondence Address: FAY SHARPE LLP, 1228 Euclid Avenue, 5th Floor, The Halle Building, Cleveland, OH, 44115, US

(73) Assignee: PRS MEDITERRANEAN LTD., Tel Aviv (IL)

(21) Appl. No.: 12/566,781

(22) Filed: Sep. 25, 2009

Related U.S. Application Data
(63) Continuation-in-part of application No. 12/238,927, filed on Sep. 26, 2008.
(60) Provisional application No. 61/115,653, filed on Nov. 18, 2008.
(60) Provisional application No. 60/975,576, filed on Sep. 27, 2007.

(51) Int. Cl. B32B 3/12; F16M 13/00

(52) U.S. Cl. 414/800; 428/116; 428/117

(57) ABSTRACT

A modular cemented planar structure is formed from a plurality of cells and a cementitious mixture. In particular, the plurality of cells can be formed by a polymeric cellular confinement system. The resulting structure is useful in many civil engineering applications. The structure allows for homogeneous curing with minimal shrinkage and cracking, as well as easy and cost effective assembly in the field.

### CROSS-REFERENCE TO RELATED APPLICATIONS

This application is a continuation-in-part of U.S. patent application Ser. No. 12/238,927, filed Sep. 26, 2008, which claimed priority to U.S. Provisional Patent Application Ser. No. 60/975,576, filed Sep. 27, 2007. The entire disclosures of these two applications are hereby fully incorporated by reference herein.

This application also claims priority to U.S. Provisional Patent Application Ser. No. 61/115,653, filed Nov. 18, 2008, the entire disclosure of which is hereby fully incorporated by reference herein.

### BACKGROUND

The present disclosure relates to modular cemented planar structures.

Cemented planar structures are common in civil engineering and are used in several applications, including tiles, floors, roofs, sound barriers, flood control, roads and parking yards and segmented toppings for pavements and bridges. Since cemented materials (e.g. concrete, cemented aggregate, and/or polymer modified concrete) are brittle, large planar structures are subjected to cracking. Cracking can be caused by mechanical stress (e.g. vibrations, static loads), thermal stress (expansion-contraction cycles), ice formation, soil pressure and earthquakes.

In order to control cracking, a common solution is to divide the planar structure into isolated domains separated by gaps. The gaps between domains can be air, polymeric material, or natural material such as wood or cloth. The gaps can be created during molding (inserts) or after curing (e.g. cutting a trench). Both processes are labor-intensive and can contaminate the remaining planar structure.

There is thus a long felt need to provide methods and/or devices that may improve the molding process of segmented modular cemented structures, having a pre-defined pattern of gaps, so the cracking process is controlled and predictable.

### BRIEF DESCRIPTION

An objective of the present disclosure to provide a method for molding or casting a mixture of cement, aggregate, and optionally water into a plurality of cells.

Disclosed in embodiments is a cemented planar structure, comprising: a plurality of cells; and a cementitious mixture within the cells.

The plurality of cells may be in the form of a cellular confinement system. Each cell may have a cylindrical cross-section. Each cell wall may have a thickness of from about 0.1 mm to about 5 mm; a cross-sectional area of from about 50 cm² to about 10,000 cm²; and/or a height of from about 1 cm to about 100 cm.

The cementitious mixture generally comprises cement, optionally aggregate, optionally water, and optionally a polymer solution or latex. Sometimes, the aggregate is a material selected from the group consisting of sand, soil, gravel, quarry waste, slag, recycled asphalt, crushed concrete, and granular material.

The cementitious mixture may comprise from about 1 to about 85 wt % cement, from 0 to about 95 wt % aggregate, from 0 to about 95 wt % polymer solution, and from 0 to about 50 wt % water. Alternatively, the cementitious mixture may comprise from about 1 to about 85 vol % cement, from 0 to about 95 vol % aggregate, from 0 to about 95 vol % polymer solution, and from 0 to about 50 vol % water.

The cement can be Portland cement. In other embodiments, the cementitious mixture comprises Portland cement, sand, optionally another aggregate, and water. In still other versions, the cementitious mixture comprises Portland cement and or/lime; a granular material selected from sand, gravel, quarry waste, slag, recycled asphalt, and crushed concrete; and water. In yet other versions, the cementitious mixture comprises Portland cement and or/lime; a polymer latex; soil; optionally a granular material selected from sand, gravel, quarry waste, slag, recycled asphalt, and crushed concrete; and water.

Disclosed in other embodiments is a cemented planar structure, comprising: a cellular confinement system; and a cementitious mixture within the cellular confinement system.

The cellular confinement system has a length, a width, and a height, and the height is less than both the width and the length. The cellular confinement system can be formed from a polymeric material.

Also disclosed are methods of using a load supporting cemented panel having a controlled cracking rate, comprising: placing the load supporting cemented panel underneath an associated load receiving surface; wherein the load supporting cemented panel comprises a cellular confinement system and a cementitious mixture within the cellular confinement system.

These and other embodiments are more fully discussed herein.

### BRIEF DESCRIPTION OF THE DRAWINGS

The following is a brief description of the drawings, which are presented for the purpose of illustrating the exemplary embodiments disclosed herein and not for the purpose of limiting the same.

FIG. 1 is a perspective view of a cellular confinement system.

FIG. 2 is a perspective view of an exemplary cemented planar structure.

FIG. 3 is a top view of an exemplary cemented planar structure.

### DETAILED DESCRIPTION

A more complete understanding of the components, processes, and apparatuses disclosed herein can be obtained by reference to the accompanying figures. These figures are merely schematic representations based on convenience and the ease of demonstrating the present development and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range from about 2 to about 4” also discloses the range “from 2 to 4.”

The cemented planar structure or panel includes a plurality of cells, which can be considered a molding matrix (MMX). A cementitious mixture is poured into the cells to form the cemented planar structure.

Each cell is a shape having open sides on the top and bottom and having vertical walls. The cell wall can be non-perforated or perforated. The cells are characterized by wall thicknesses of about 0.1 mm to about 5 mm, a cross-sectional area of from about 50 to about 10,000 square centimeters (cm²), and/or a cell height of from about 1 cm to about 100 cm. The cells can have a cylindrical cross-section or any polygonal cross-section.

In some embodiments, the cells are arranged as a plurality of honeycomb-like structures. In other embodiments, the plurality of cells is arranged as a cellular confinement system or geocell.

In other embodiments, the cell wall is made of polymeric material.

The process of molding or casting the cemented planar structure comprises the steps of mixing, molding, and curing. First, the cementitious mixture is mixed together. The mixture can include cementing agent (i.e. cement), optionally aggregate, optionally polymer solution or latex, and optionally water. The ingredients are mixed together to form a dry powder, plastic paste, or a liquid mass.

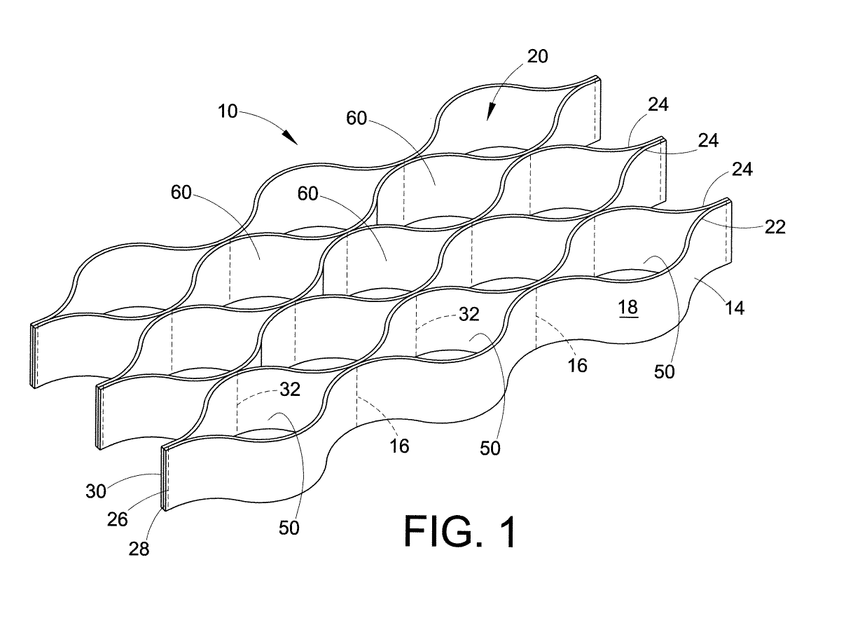

The mixture is then molded or cast into the molding matrix. The powder/paste/liquid mass can be poured, force-fed, or pressed into the cells. The cementitious mixture is generally poured into all of the cells in the molding matrix/cellular confinement system. Some properties of the final cemented planar structure can, however, be tuned by changing the distribution of cement within the cells of the molding matrix. For example, filling some cells and leaving other cells empty would change the manner in which the final planar structure cracks throughout its lifetime. In embodiments, the cementitious mixture is poured into cells located within the interior of the cellular confinement system/geocell (see FIG. 1 below). Typically, at least 95% of the cells in the geocell are filled with the cementitious mixture.

Optionally, pressure may be applied / provided to compact the cementitious mixture prior to curing. Optionally, the horizontal surfaces may also be smoothed so the cementitious mixture does not protrude out of the top or bottom of the molding matrix.

The cementitious mixture is then cured in the molding matrix to obtain the desired/designed stiffness, strength and density.

The result is a plurality of cemented material plates or columns. Each plate/column has vertical walls in the shape provided by the molding matrix, and the upper and lower faces are open to air.

In one embodiment, the cementitious mixture is a mixture of Portland cement, sand, optionally other aggregate, and water.

In another embodiment, the cementitious mixture (i.e. cemented material) is a mixture of Portland cement and or/lime; granular materials selected from sand, gravel, quarry waste, slag, recycled asphalt, and crushed concrete; and water.

In another embodiment, the cemented material is a mixture of Portland cement and or/lime; polymer latex; native soil; optionally granular materials selected from sand, gravel, quarry waste, slag, recycled asphalt, and crushed concrete; and water.

Generally, the cementitious mixture comprises from about 1 to about 85% cement, from 0 to about 95% aggregate, from 0 to about 95% polymer solution, and from 0 to about 50% water. The percentages may be in terms of weight or volume.

Exemplary aggregate materials that can be included in the cementitious mixture include recycled aggregates such as crushed concrete, recycled asphalt, and glass. Additional aggregate materials include other cemented granular materials, such as quarry waste.

If desired, multiple different cementitious mixtures can be placed in different cells of the geocell to tune the overall properties of the final cemented panel. However, only one cementitious mixture is generally used for convenience.

The molded composite planar structures have very useful properties. They can be easily and cost effectively molded in the field for use as roads, bridges, and/or acoustic walls. The polymeric molding matrix can be shipped in a collapsed form, and expanded prior to molding or casting of the cement mixture in the field. The molding matrix defines very accurately the module size, thus enabling design and long term performance prediction of the overall cemented planar structure. The polymeric walls of the molding matrix confine the cement mixture, thus enabling homogeneous curing with minimal shrinkage and cracking. The polymeric wall around every cemented module also serves as an expansion joint, thus enabling the cemented planar structure to be used throughout a very wide temperature range (from minus 60° C. to plus 90° C.) without significant cracking. These properties make the planar structure useful in load support applications.

Cellular confinement systems have been traditionally used to support vertical faces, for example as linings on the side of channels to prevent erosion of, e.g., soil or sand that might otherwise fill in the bottom of the channel. In such applications, the fill material in the cellular confinement system does not experience large changes in load. However, in load support applications, such as under a road, the fill material will experience both static and dynamic loads. The cellular confinement system or geocell helps control the cracking of the overall cemented planar structure. The cemented flat panel thus has a controlled and predictable cracking mode. In addition, compared to a simple concrete slab that does not have a geocell, the cemented planar structure can begin to bear loads earlier in time. This advantage is very important from an economical standpoint; for example, a road or parking lot can begin to be used earlier than otherwise possible, generating revenue sooner.

Some typical applications that may use the novel modular cemented planar structure are: Reconstituted roads, wherein the planar structure is a topping on top of granular material or old asphalt or concrete; Storage and parking yards; Playgrounds; Industrial flooring; and Unpaved roads, wherein the molding matrix is filled with cemented native soil or cemented granular material. This planar structure is suitable for load support applications, when it is placed under other structures such as roads, airports, parking lots, railways (below the ballast), etc.

FIG. 1 is a perspective view of a single layer geocell which can be used to provide the plurality of cells. The geocell 10 comprises a plurality of polymeric strips 14. Adjacent strips are bonded together by discrete physical joints 16. The bonding may be performing by bonding, sewing or welding, but is generally done by welding. The portion of each strip between two joints 16 forms a cell wall 18 of an individual cell 20. Each cell 20 has cell walls made from two different polymeric strips. The strips 14 are bonded together to form a honeycomb pattern from the plurality of strips. For example, outside strip 22 and inside strip 24 are bonded together by physical joints 16 which are regularly spaced along the length of strips 22 and 24. A pair of inside strips 24 is bonded together by physical joints 32. Each joint 32 is between two joints 16. As a result, when the plurality of strips 14 is stretched in a direction perpendicular to the faces of the strips, the strips bend in a sinusoidal manner to form the geocell 10. At the edge of the geocell where the ends of two polymeric strips 22, 24 meet, an end weld 26 (also considered a joint) is made a short distance from the end 28 to form a short tail 30 which stabilizes the two polymeric strips 22, 24. The cell walls may be perforated or non-perforated. Some cells can be considered edge cells 50, with others are considered interior cells 60. Generally, those cells on the outermost perimeter of the geocell are considered edge cells. Put another way, the cells not forming the perimeter of the geocell are considered interior cells. It should be noted that the edge cells are located along all four sides of the geocell. As depicted in FIG. 1, there are a total of 13 cells; eight of them should be considered edge cells and the other five would be considered interior cells.

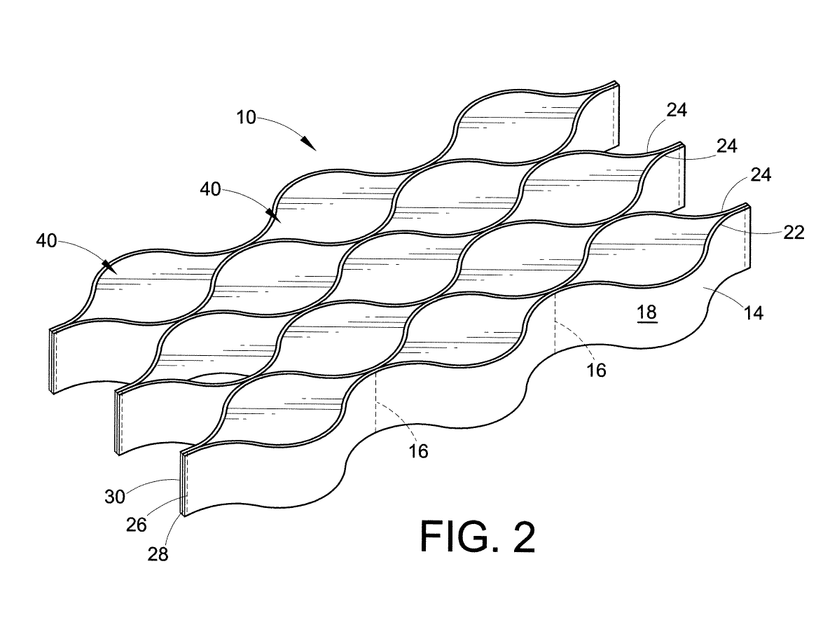

FIG. 2 is a perspective view of the geocell 10 after the cementitious mixture has been poured into the cells. Multiple cemented columns 40 are formed after curing. In some embodiments, the cementitious mixture is poured, and cemented columns are subsequently formed, only in the edge cells (i.e. on all four edges) of the geocell and not in the interior cells. In other embodiments, the cementitious mixture is not poured in the edge cells, but is poured in only some of the interior cells. In other embodiments, the cementitious mixture is poured in all of the edge cells and all of the interior cells.

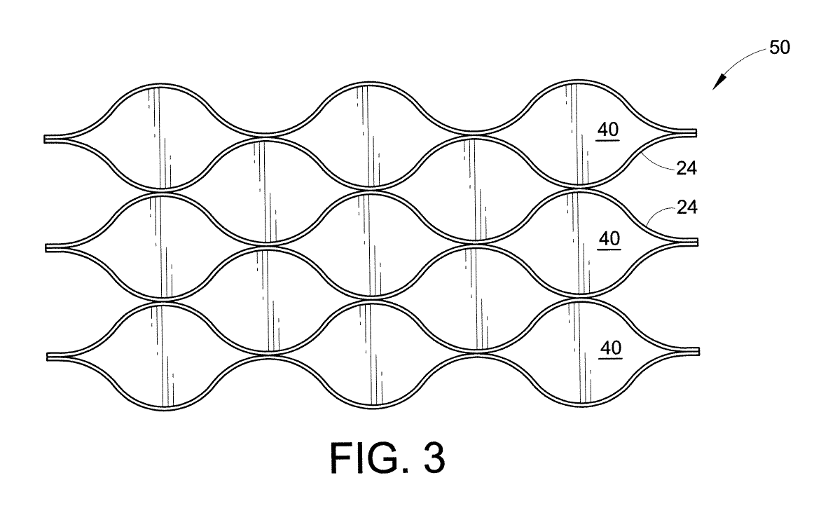

FIG. 3 is a top view of the cemented planar structure 50. The cell walls 24 separate the columns 40 from each other.

The present disclosure has been described with reference to exemplary embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A cemented planar structure, comprising:
a plurality of cells; and
a cementitious mixture within the cells.

2. The planar structure of claim 1, wherein the plurality of cells is in the form of a cellular confinement system.

3. The planar structure of claim 1, wherein each cell has a cylindrical cross-section.

4. The planar structure of claim 1, wherein each cell wall has a thickness of from about 0.1 mm to about 5 mm.

5. The planar structure of claim 1, wherein each cell wall has a cross-sectional area of from about 50 cm² to about 10,000 cm².

6. The planar structure of claim 1, wherein each cell wall has a height of from about 1 cm to about 100 cm.

7. The planar structure of claim 1, wherein the cementitious mixture comprises cement, optionally aggregate, optionally water, and optionally a polymer solution or latex.

8. The planar structure of claim 7, wherein the aggregate is a material selected from the group consisting of sand, soil, gravel, quarry waste, slag, recycled asphalt, crushed concrete, and granular material.

9. The planar structure of claim 7, wherein the cementitious mixture comprises from about 1 to about 85 wt % cement, from 0 to about 95 wt % aggregate, from 0 to about 95 wt % polymer solution, and from 0 to about 50 wt % water.

10. The planar structure of claim 7, wherein the cementitious mixture comprises from about 1 to about 85 vol % cement, from 0 to about 95 vol % aggregate, from 0 to about 95 vol % polymer solution, and from 0 to about 50 vol % water.

11. The planar structure of claim 7, wherein the cement is Portland cement.

12. The planar structure of claim 1, wherein the cementitious mixture comprises Portland cement, sand, optionally another aggregate, and water.

13. The planar structure of claim 1, wherein the cementitious mixture comprises Portland cement and or/lime; a granular material selected from sand, gravel, quarry waste, slag, recycled asphalt, and crushed concrete; and water.

14. The planar structure of claim 1, wherein the cementitious mixture comprises Portland cement and or/lime; a polymer latex; soil; optionally a granular material selected from sand, gravel, quarry waste, slag, recycled asphalt, and crushed concrete; and water.

15. A cemented flat panel having a controlled and predictable cracking mode, comprising:
a cellular confinement system; and
a cementitious mixture within the cellular confinement system.

16. The flat panel of claim 15, wherein the cellular confinement system has a length, a width, and a height, and the height is less than both the width and the length.

17. The flat panel of claim 15, wherein the cellular confinement system is formed from a polymeric material.

18. The flat panel of claim 15, wherein the cementitious mixture comprises cement, optionally aggregate, optionally water, and optionally a polymer solution or latex.

19. The flat panel of claim 18, wherein the cementitious mixture comprises from about 1 to about 85 wt % cement, from 0 to about 95 wt % aggregate, from 0 to about 95 wt % polymer solution, and from 0 to about 50 wt % water.

20. A method of using a load supporting cemented panel having a controlled cracking rate, comprising:
placing the load supporting cemented panel underneath an associated load receiving surface;
wherein the load supporting cemented panel comprises a cellular confinement system and a cementitious mixture within the cellular confinement system.
